(19) United States
(12) Patent Application Publication
(10) Pub. No.: US 2026/0273652 A1
(43) Pub. Date: Sep. 17, 2026

(54) MOBILE IMAGING DEVICE, IMAGING SYSTEM, IMAGING ARRANGEMENT, AND IMAGING METHOD FOR IMAGING A CUT EDGE

(71) Applicant: TRUMPF Werkzeugmaschinen SE + Co. KG, Ditzingen (DE)

(72) Inventors: Philipp Leube, Stuttgart (DE); Korbinian Weiss, Korntal (DE); Manuel Geiger, Möglingen (DE); Aastha Aastha, Ludwigsburg (DE); Willi Pönitz, Leonberg (DE)

(21) Appl. No.: 19/671,287

(22) Filed: May 8, 2026

Related U.S. Application Data
(63) Continuation of application No. PCT/EP2024/082216, filed on Nov. 13, 2024.

(30) Foreign Application Priority Data
Nov. 13, 2023 (DE) 10 2023 131 519.6

(51) Int. Cl. B23K 26/00; B23K 26/03; B23K 26/035; B23K 26/38; B23K 26/70

(52) U.S. Cl. CPC B23K 26/0096; B23K 26/032; B23K 26/037; B23K 26/38; B23K 26/702

(57) ABSTRACT

A mobile imaging device location-independently generates at least one image of a cut edge of a workpiece. The imaging device includes a main body with a cut-edge stop, which is located or formed on the main body and configured to be placed arranged or formed on the main body, for placing the main body against the workpiece having the cut edge to be imaged; and an imaging unit, which is located in or on the main body and configured to image the cut edge. The cut-edge stop forms a predetermined edge distance to the imaging unit along an optical imaging axis of the imaging unit. The predetermined edge distance causes a constant imaging distance of the imaging unit to the cut edge when the imaging device is placed on the workpiece.

### CROSS REFERENCE TO RELATED APPLICATIONS

This application is a continuation of International Application No. PCT/EP 2024/082216 (WO 2025/104104 A1), filed on Nov. 13, 2024, and claims benefit to German Patent Application No. DE 10 2023 131 519.6, filed on Nov. 13, 2023. The aforementioned applications are hereby incorporated by reference herein.

### FIELD

The present disclosure relates to a mobile imaging device, imaging system, imaging arrangement, and imaging method for imaging a cut edge.

### BACKGROUND

The cutting quality in the production of workpieces using laser cutting is usually captured and evaluated by image-based computer methods, for example using machine learning methods. Based on the detected cutting quality, method and machine parameters can be adjusted or corrected to maintain and/or optimize the cutting quality during production.

However, the quality of the results from such computer methods depends to a considerable extent on the quality of the images being evaluated. Changing conditions, especially changes in the shooting position and/or shooting angle when taking the pictures, can significantly impair the quality of the recordings.

From WO 2022/157310 A1, a device for analyzing a cut edge of a workpiece is known. The workpiece is held in a workpiece holder at predetermined lighting angles to enable a high-quality image of the cut edge.

However, the known device can only inadequately meet the requirements for the quality of the image recordings.

For example, for conventional devices, the workpiece typically has to be arranged in an imaging device, which requires additional work steps to determine the cutting quality. The effort typically increases with the size and weight of the workpieces. Furthermore, the imaging of the cut edge is often significantly hampered in such unwieldy workpieces or is not possible at all, for example due to the available imaging space. In order to monitor the cutting quality, test pieces often have to be produced, which, however, reduce production capacity and lead to rejects.

### SUMMARY

In an aspect, the present disclosure provides a mobile imaging device for location-independent generation of at least one image of a cut edge of a workpiece. The imaging device includes a main body with a cut-edge stop, which is located or formed on the main body and configured to be placed arranged or formed on the main body, for placing the main body against the workpiece having the cut edge to be imaged; and an imaging unit, which is located in or on the main body and configured to image the cut edge. The cut-edge stop forms a predetermined edge distance to the imaging unit along an optical imaging axis of the imaging unit. The predetermined edge distance causes a constant imaging distance of the imaging unit to the cut edge when the imaging device is placed on the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a mobile imaging device in a perspective view;

FIG. 2 shows an imaging arrangement with an imaging system having the imaging device from FIG. 1 and a workpiece in a schematic representation; and

FIG. 3 schematically shows an imaging method for generating images of cut edges on workpieces.

### DETAILED DESCRIPTION

Aspects of the present disclosure provide a device and a method with which a simple image of the cut edge can be produced with reproducibly high image quality.

An aspect of the present disclosure provides a mobile imaging device. The mobile imaging device is designed for mobile use. In other words, the mobile imaging device can be used in a location-independent manner. This allows the imaging device to be used, for example, inside a machine tool and/or in the vicinity of a machine tool. In this way, a cut edge can be imaged particularly easily at the point where the cut edge is formed.

In an aspect, the mobile imaging device is designed to generate at least one image of a cut edge of a workpiece. Typically, the mobile imaging device is designed to image a multitude of cut edges on various workpieces.

In an aspect, the mobile imaging device has a main body. The main body is typically made of a plastic. This allows the imaging device to be designed to be robust and lightweight, thus simplifying handling.

In an aspect, the main body has a cut-edge stop. The cut-edge stop may be located or formed on the main body. Typically, the cut-edge stop is manufactured in one piece with the main body or formed on the main body. Alternatively or additionally, it can be provided that the cut-edge stop is arranged on the main body by means of known fastening means. Furthermore, it is conceivable that the cut-edge stop is designed in multiple parts, wherein a first part of the cut-edge stop is formed on the main body and a second part is attached to the main body, in particular aspects to the first part of the cut-edge stop.

In an aspect, the cut-edge stop is designed for placing the main body against the workpiece which has the cut edge to be imaged. In other words, the cut-edge stop forms a contact section between the workpiece and the imaging device when the imaging device is located on the workpiece.

In an aspect, the imaging device has at least one imaging unit. Preferably, the imaging device has exactly one imaging unit. The imaging unit is to be understood as a sub-device designed to generate a graphic representation of the cut edge. Typically, the imaging unit has at least one camera or is designed as a camera. The imaging unit can, for example, be designed as a smartphone.

In an aspect, the camera preferably has a resolution of at least 0.5 megapixels, and particularly preferably at least 1.0 megapixels. Further preferably, the camera has a resolution of no more than 5.0 megapixels, particularly preferably no more than 2.0 megapixels. The inventors of the present disclosure have recognized that cameras with the resolutions described above are particularly well suited for imaging cut edges in terms of resolution accuracy, imaging speed, storage requirements and evaluation effort.

In an aspect, the imaging unit can be located or positioned in or within the main body. In other words, the main body can enclose the imaging unit, with the main body having at least one imaging aperture for imaging the cut edge. Alternatively, the imaging unit can be arranged on the main body. In other words, the imaging unit can be attached to an outer side of the main body.

In an aspect, the imaging unit can be attached permanently to the main body, for example by a non-destructive, non-removable arrangement, or attached detachably, by a clamping or screwed arrangement. For example, the latter allows for the temporary positioning of a smartphone as an imaging unit on the main body. This allows the imaging device to be provided particularly cost-effectively.

In an aspect according to the present disclosure, the cut-edge stop forms an edge distance to the imaging unit that is predetermined along an optical imaging axis of the imaging unit. The edge distance is preferably aligned with the focus position of the imaging unit. This allows for particularly simple imaging of the cut edge in the imaging plane of the imaging unit.

In an aspect, the predetermined edge distance ensures a constant imaging distance between the imaging device and the cut edge when the imaging device is placed on the workpiece. In other words, the distance between the imaging unit and a cut edge of a workpiece to be imaged can be kept the same for different workpieces and different imaging methods. This allows for a consistently high image quality while using a simple imaging method.

An aspect of the present disclosure provides a mobile imaging device which, by means of a cut-edge stop, enables the imaging device to be repeatedly applied to different workpieces with cut edges to be imaged. The distance between the imaging device and the cut edge can be kept constant in a particularly simple way, so that images of consistently high quality can be generated. This further simplifies the evaluation of the cutting quality of a machine tool and the subsequent modification or optimization of the machine parameters and/or manufacturing process parameters for cutting workpieces.

In a preferred aspect, the mobile imaging device has a handle which is located or formed on the main body. In other words, the main body has the handle. The handle is designed for one-handed operation of the mobile imaging device. Preferably, the handle is ergonomically shaped to further improve handling. The handle is particularly preferably designed in a “pistol-like” design, which allows for particularly safe handling of the handle.

In a preferred further aspect, the mobile imaging device also has a trigger arranged on the handle. The trigger is designed to generate the image of the cut edge when the imaging device is placed against the workpiece. In other words, the trigger activates the imaging unit, thereby generating the image of the cut edge. This can further simplify the handling of the imaging device. The trigger can preferably be designed to be triggered by the index finger of a human hand.

In an aspect, the mobile imaging device is preferably designed so that the cut-edge stop is adjustable along the optical imaging axis. The cut-edge stop is preferably designed to be movable and fixable along the optical imaging axis. Particularly preferably, the cut-edge stop is designed to be at least two-part, wherein one part of the cut-edge stop is designed to be deflectable relative to a second part of the cut-edge stop. After deflection of the movable part, it can preferably be fixed in relation to the second part of the cut-edge stop. This allows the imaging distance to be adjusted to a changed focus position or to changed image dimensions of the imaging unit, thereby improving the imaging flexibility of the imaging device.

In a preferred aspect of the mobile imaging device, it has a cover which is located or formed on the main body. The cover is designed to protect the imaging unit from interference caused by external light. This can improve the image accuracy, in particular the image sharpness.

In an aspect, the mobile imaging device is preferably designed such that the main body has an alignment stop which is located or formed thereon. When the imaging device is placed against the workpiece, the alignment stop ensures a perpendicular alignment of the optical imaging axis to the cut edge. In other words, the alignment stop typically has a predetermined stop angle relative to the cut-edge stop. The stop angle is preferably designed to adjust to the contour of the workpiece.

In a preferred aspect, the mobile imaging device has a light source which is located on or in the main body. The light source is directed towards the cut edge when the imaging device is located on the workpiece. In other words, the light source is designed to illuminate the cut edge during the generation of the image. The light source can have one or a plurality of light bulbs. Preferably, the light source is designed as a so-called dome light, which ensures particularly even illumination of the cut edge. This can further improve the quality of the image.

In an aspect, the mobile imaging device is further preferably designed such that the imaging unit is formed within the main body. In other words, the imaging unit is integrally located and formed within the main body. This can provide a particularly high level of protection for the imaging unit against damage.

In a preferred aspect, the mobile imaging device, in particular the imaging unit, has a communication module for exchanging data. Data can be exchanged, for example, using a data cable. Preferably, the communication module is designed for wireless data exchange, in particular via Bluetooth. This can further improve the handling of the imaging device.

An aspect of the present disclosure provides an imaging system. The imaging system is suitable and designed for generating images of cut edges on workpieces. Typically, the imaging system is designed to store the images. Preferably, the imaging system is designed for further processing or evaluation of the images.

In an aspect, the imaging system includes at least one mobile imaging device as described above and below. Preferably, the imaging system has at least two or more imaging devices as described above and below. This allows the imaging system to be designed particularly efficiently and enables the simultaneous imaging of a plurality of cut edges.

In an aspect, the imaging system includes an evaluation unit for storing the images generated by the imaging device. Typically, the evaluation unit is designed to communicate with a communication module of the mobile imaging device. Communication between the evaluation unit and the mobile imaging device enables the exchange of data, in particular of generated images.

Data can be exchanged via cable or wired connection. Preferably, the data is exchanged wirelessly, particularly preferably via Bluetooth.

In a preferred aspect, the imaging system has a machine tool. The machine tool is designed for forming, in particular cutting, a cut edge on a workpiece. Preferably, the machine tool is designed as a laser processing machine, wherein the processing of the workpiece or the formation of the cut edge is carried out by means of a processing laser. The evaluation unit can be integrated into the machine tool, in particular into a control system of the machine tool. This allows for a particularly fast evaluation of the image in conjunction with a fast evaluation.

An aspect of the present disclosure provides an imaging arrangement. The imaging arrangement is suitable and designed for generating images of cut edges on workpieces.

In an aspect, the imaging arrangement comprises an imaging system described above and below, with at least one imaging device described above and below. Preferably, the imaging arrangement comprises two or more imaging devices as described above and below.

In an aspect, the imaging arrangement includes a workpiece with a cut edge to be imaged.

In an aspect, the mobile imaging device is designed to be placed against the workpiece to image the cut edge. In a special design, the mobile imaging device is located on the workpiece.

In a particular aspect of the imaging arrangement, the cut-edge stop and the alignment stop are designed to be complementary to a contour section of the workpiece. In other words, the cut-edge stop and the alignment stop are located on different sides of the workpiece. Preferably, by placing the cut-edge stop and the alignment stop on the workpiece, the optical imaging axis of the imaging unit is formed perpendicular to the cut edge.

An aspect of the present disclosure provides an imaging method. The imaging method is designed to generate images of cut edges on workpieces using a previously described imaging arrangement.

In an aspect, the imaging method has at least the following method steps: in the first step of the imaging method, the mobile imaging device is located on the workpiece. The workpiece typically has at least one cut edge to be imaged. The mobile imaging device is positioned by placing the cut-edge stop of the mobile imaging device on the workpiece. This allows a predetermined distance to be maintained between the imaging unit and the cut edge.

In a further step of an aspect of the imaging method, the imaging of the cut edge is created by triggering the imaging unit. Preferably, the triggering is carried out by means of a trigger on the imaging device. The trigger is particularly preferably arranged on a handle of the imaging device.

In a preferred aspect of the imaging method, the mobile imaging device is additionally arranged on the workpiece by placing the alignment stop on the workpiece. In other words, the device is placed against the workpiece by means of the cut-edge stop and the alignment stop. This ensures that, in addition to the predetermined imaging distance, a predetermined imaging angle can also be guaranteed. This allows for further improvement and reproducibility of the imaging of cut edges.

In a further preferred aspect, the imaging method includes the additional method step of transmitting the image to the evaluation unit of the imaging system.

Further advantages of the present disclosure are evident from the description and the drawings. Similarly, the features mentioned above and the features still to be explained may each be used on their own or together in any desired combinations according to the present disclosure. The embodiments shown and described should not be understood as an exhaustive list, but rather are of an exemplary character.

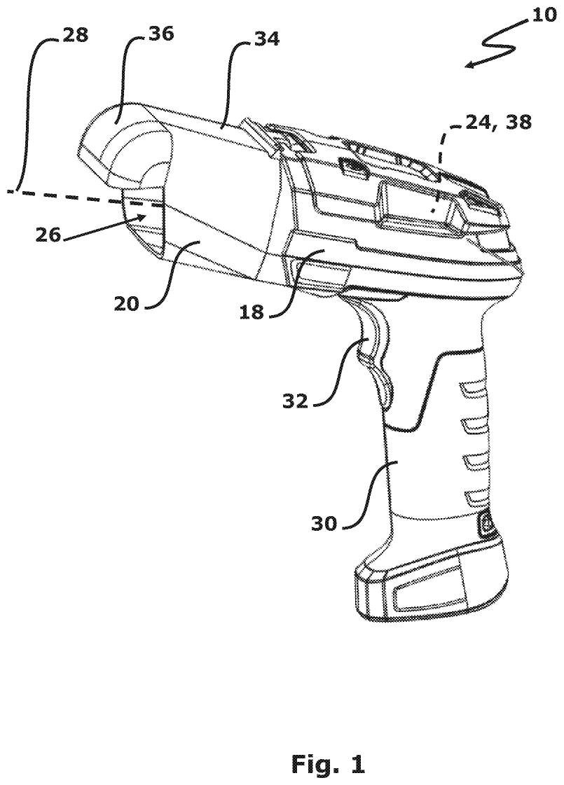

FIG. 1 shows a first embodiment of a mobile imaging device 10 according to the present disclosure.

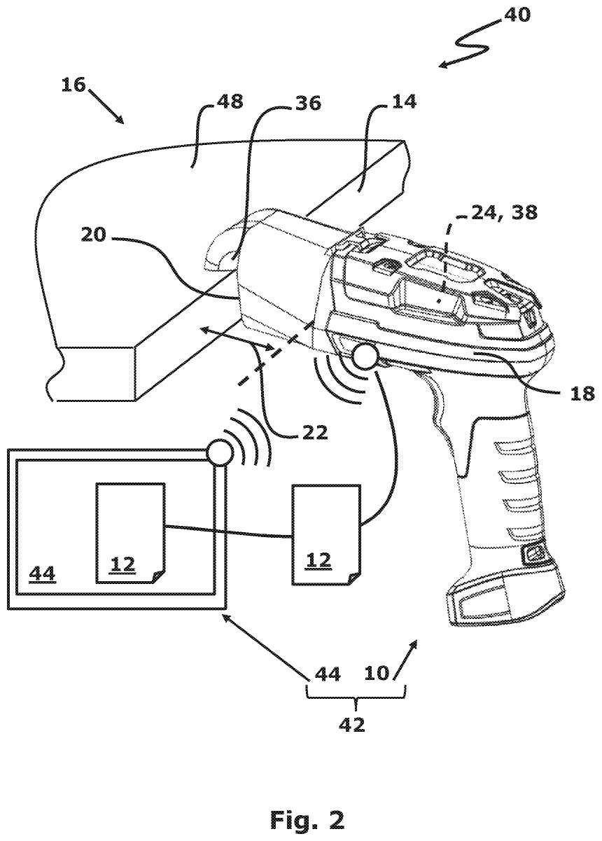

The imaging device 10 is designed for the location-independent generation of at least one image 12 (see FIG. 2) of a cut edge 14 (see FIG. 2) of a workpiece 16 (see FIG. 2).

The imaging device 10 comprises a main body 18 and a cut-edge stop 20 arranged on the main body 18 as shown in the illustration.

The cut-edge stop 20 is designed to be placed against the workpiece 16 which has the cut edge 14 to be imaged. By placing the cut-edge stop 20 against the workpiece 16, positioning of the main body 18 at a predetermined edge distance 22 (see FIG. 2) can be ensured.

The imaging device 10 also includes an imaging unit 24. As illustrated, the imaging unit 24 is arranged within the main body 16 and is substantially enclosed by it (represented by a dashed reference line). The imaging unit 24 is preferably designed as a camera. The imaging unit 24 is designed to image the cut edge 14. The imaging unit 24 is preferably arranged or attached immovably to the main body 18.

The main body 18 and/or the cut-edge stop 20 preferably have an imaging recess 26, through which the imaging unit 24 generates the image 12 of the cut edge 14. In other words, an optical imaging axis 28 of the imaging unit 24 is directed through the imaging recess 26.

The cut-edge stop 20 thus forms the edge distance 22 to the imaging unit 24 predetermined along the optical imaging axis 28 of the imaging unit 24 when the imaging device 10 is placed against the workpiece 16. This ensures a constant imaging distance between the imaging device 24 and the cut edge 14.

The cut-edge stop 20 can be detachably attached to the main body 18 to make replacing the cut-edge stop 20 easy. A replacement of the cut-edge stop 20 may be necessary if an image 12 is to be created under changed conditions.

Alternatively or additionally, the cut-edge stop 20 can be adjustable along the optical imaging axis 28. This makes it particularly easy to adjust the imaging distance to a changed focus position or changed image dimensions.

As illustrated, the mobile imaging device 10 can have a handle 30 which is located or formed on the main body 18. The handle 30 is preferably designed for one-handed operation of the mobile imaging device 10 by an operator. Typically, the handle 30 is shaped like a pistol, as shown.

As shown, the mobile imaging device 10 can further comprise a trigger 32 located on the handle 30 for generating the image 12 of the cut edge 14 when the imaging device 10 is placed against the workpiece 16. The trigger 32 is typically designed to trigger the imaging unit 24. Preferably, the trigger 32 is designed to be triggered by an index finger of a human hand of an operator.

The mobile imaging device 10 may further have a cover 34 which is located or formed on the main body 18. The cover 34 is integrally formed on the cut-edge stop 20, as shown. The cover 34 reliably protects the imaging unit 24 from interference caused by external light, thereby further improving the image quality.

Furthermore, the mobile imaging device 10 includes an alignment stop 36, as illustrated. The alignment stop 36 is integrally formed on the cut-edge stop 20, as shown. The alignment stop 36 preferably causes the optical imaging axis 28 to be aligned perpendicularly to the cut edge 14 when the imaging device 10 is placed against the workpiece 16. The imaging device 10 can therefore be positioned at a constant imaging angle in addition to the constant edge distance 22. This allows the imaging device 10 to be positioned even more precisely, thereby further improving the image quality.

Furthermore, the mobile imaging device 10, or the imaging unit 24, can include a communication module 38. The communication module 38 is designed for the, in particular wireless, exchange of data. Typically, the communication module 38 is designed to transmit images 12 of the cut edge 14 generated by the imaging unit 24. The communication module 38 is typically arranged within the main body 18, which is represented by a dashed reference line.

FIG. 2 shows an imaging arrangement 40 with an imaging system 42 and the workpiece 16.

The imaging system 42 is designed to generate the image 12 of the cut edge 14 of the workpiece 16. Typically, the imaging system 42 is designed to generate a multitude of images 12 of different cut edges 14.

The imaging system 42, as illustrated, includes the mobile imaging device 10 as shown in FIG. 1. The imaging system 42 preferably has two or more mobile imaging devices 10. This can facilitate the parallel generation of images 12.

The imaging system 42 also has an evaluation unit 44 for storing the images 12 generated by the imaging device 10. Preferably, the evaluation unit 44 is designed to evaluate the images 12. This allows subsequent processes to be carried out particularly quickly and easily. The evaluation unit 44 is particularly preferably arranged in a machine tool and/or integrated into a machine control system of the machine tool. This allows an evaluation of the images 12 to be used directly for optimizing manufacturing parameters.

The evaluation unit 44 is typically connected to the imaging unit 10 for the exchange of data, here the image 12. The data connection can be established using a data cable. Preferably, the data connection is wireless, in particular between the evaluation unit 44 and the communication module 38, which allows the mobile imaging unit 10 to be used in a particularly flexible manner.

As shown, the imaging arrangement 40 is suitable and designed to generate one or more images 12 of the cut edge 14.

The mobile imaging unit 10 is designed for placing on the workpiece 16. According to the illustrated imaging arrangement 40, the imaging device 10 is placed against the workpiece 16. The cut-edge stop 20 rests against the cut edge 14 to be imaged and distances the main body 18 of the imaging device 10 by the edge distance 22. This allows the imaging unit 24 to be positioned at a predetermined distance, in particular a focus position, from the cut edge 14, thereby increasing the image quality.

Furthermore, as illustrated, the alignment stop 36 is placed against an upper face 48 of the workpiece 16. This allows the alignment of the main body 18 to the cut edge 14, or the imaging angle of the imaging unit 24, to be set in a repeatable manner. In other words, an image 12 can be generated at the same edge distance 22 and the same image angle to the cut edge 14. Preferably the imaging angle, or the optical axis 28 (see FIG. 1) of the imaging unit 24 is designed perpendicular to the cut edge 14.

As illustrated, the cut-edge stop 20 and the alignment stop 36 are designed to be complementary to a contour section of the workpiece 16. This makes repeatable positioning of the imaging device 10 particularly easy and quick.

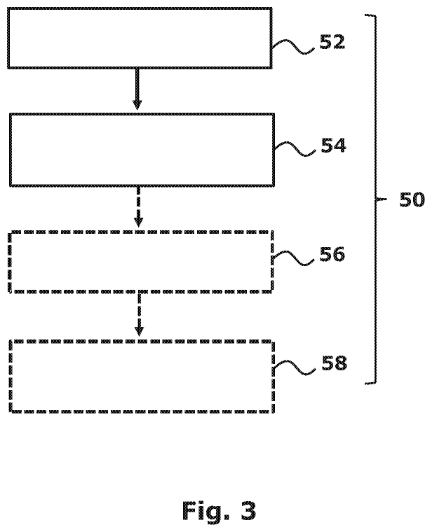

FIG. 3 shows an imaging method 50 for generating images 12 (see FIG. 2) of cut edges 14 (see FIG. 2) on workpieces 16 (see FIG. 2) with an imaging arrangement 40 (see FIG. 2).

The imaging arrangement 40 is preferably the imaging arrangement 40 from FIG. 2.

The imaging method 50 has at least the following method steps:

In a step 52 of the imaging method, the mobile imaging device 10 is located on the workpiece 16. The workpiece 16 typically has at least one cut edge 14 to be imaged.

The imaging device 10 is typically arranged by placing the cut-edge stop 20 (see FIGS. 1 and 2) of the mobile imaging device 10 against the workpiece 16, or the cut edge 14. This positions the imaging device 10, or an imaging unit 24, at a predetermined distance from the cut edge 14.

A further method step 54 of the imaging method 50 involves creating the image 12 of the cut edge 14 by triggering the imaging unit 24. Preferably, the imaging unit 24 is triggered by actuating a trigger 32 (see FIG. 1). The trigger 32 is typically located or formed on, in particular a handle 30 of, the imaging device 10.

An additional method step 56 of the imaging method 50 can provide that the mobile imaging device 10 is additionally located on the workpiece 16 by placing the alignment stop 36 (see FIGS. 1 and 2) against the workpiece 16. This allows the imaging unit 24 to be positioned repeatably at both the predetermined imaging distance and a predetermined imaging angle.

A further method step 58 of the imaging method 50 can provide for the transmission of the image 12 to the evaluation unit 44 (see FIG. 2) of the imaging system 42. This facilitates rapid further processing of the generated image 12.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Mobile imaging device
12 Image
14 Cut edge
16 Workpiece
18 Main body
20 Cut-edge stop
22 Edge distance
24 Imaging unit
26 Imaging recess
28 Optical imaging axis
30 Handle
32 Trigger
34 Cover
36 Alignment stop
38 Communication module
40 Imaging arrangement
42 Imaging system
44 Evaluation unit
48 Upper face
50 Imaging method
52 Method step
54 Method step
56 Method step
58 Method step

1. A mobile imaging device for location-independent generation of at least one image of a cut edge of a workpiece, comprising:
a main body with a cut-edge stop, which is located or formed on the main body and configured to be placed arranged or formed on the main body, for placing the main body against the workpiece having the cut edge to be imaged; and
an imaging unit, which is located in or on the main body and configured to image the cut edge,
wherein the cut-edge stop forms a predetermined edge distance to the imaging unit along an optical imaging axis of the imaging unit, and
wherein the predetermined edge distance causes a constant imaging distance of the imaging unit to the cut edge when the imaging device is placed on the workpiece.

2. The mobile imaging device according to claim 1, further comprising a handle which is located or formed on the main body, wherein the handle is configured for one-handed operation of the mobile imaging device.

3. The mobile imaging device according to claim 2, further comprising a trigger arranged on the handle for generating the at least one image of the cut edge when the imaging device is placed against the workpiece.

4. The mobile imaging device according to claim 1, wherein the cut-edge stop is configured to be adjustable along the optical imaging axis.

5. The mobile imaging device according to claim 1, further comprising a cover which is located or formed on the main body, wherein the cover protects the imaging unit from interference caused by external light.

6. The mobile imaging device according to claim 1, wherein the main body has an alignment stop which is located or formed on the main body, wherein the alignment stop causes a perpendicular alignment of the optical imaging axis to the cut edge when the imaging device is placed against the workpiece.

7. The mobile imaging device according to claim 1, further comprising a light source which is located or formed on the main body for illuminating the cut edge during the generation of the at least one image.

8. The mobile imaging device according to claim 1, wherein the imaging unit is formed within the main body.

9. The mobile imaging device according to claim 1, wherein the imaging unit has a communication module for wirelessly exchanging data.

10. An imaging system for generating images of cut edges on workpieces, comprising the mobile imaging device according to claim 1, and an evaluation unit for storing the at least one image generated by the imaging device, wherein the mobile imaging device has a communication module, wherein the evaluation unit is connected to the imaging unit for exchanging data.

11. The imaging system according to claim 10, further comprising a machine tool for cutting the cut edge on the workpiece, wherein the evaluation unit is integrated into the machine tool.

12. An imaging arrangement for generating images of cut edges on workpieces, comprising the imaging system according to claim 10 and the workpiece with the cut edge to be imaged, wherein the mobile imaging device for imaging the cut edge is configured to be attached to the workpiece.

13. The imaging arrangement according to claim 12, wherein the main body has an alignment stop which is located or formed on the main body, wherein the alignment stop causes a perpendicular alignment of the optical imaging axis to the cut edge when the imaging device is placed against the workpiece, and wherein the cut-edge stop and the alignment stop are configured to be complementary to a contour section of the workpiece.

14. An imaging method for generating at least one image of a cut edge on a workpiece, having a mobile imaging device comprising a main body with a cut-edge stop, which is located or formed on the main body and configured to be placed arranged or formed on the main body, for placing the main body against the workpiece having the cut edge to be imaged, and an imaging unit, which is located in or on the main body and configured to image the cut edge, having an imaging system comprising an evaluation unit for storing the at least one image generated by the imaging device, wherein the mobile imaging device has a communication module, wherein the evaluation unit is connected to the imaging unit, and having an imaging arrangement comprising the workpiece with the cut edge to be imaged, wherein the mobile imaging device for imaging the cut edge is configured to be attached to the workpiece, the method comprising:
arranging the mobile imaging device on the workpiece with the cut edge to be imaged by placing the cut-edge stop of the mobile imaging device against the workpiece; and
creating the at least one image of the cut edge by triggering the imaging unit.

15. The imaging method according to claim 14, wherein the main body has an alignment stop which is located or formed on the main body, wherein the alignment stop causes a perpendicular alignment of an optical imaging axis to the cut edge when the imaging device is placed against the workpiece, wherein positioning of the mobile imaging device on the workpiece is additionally carried out by applying the alignment stop to the workpiece.

16. The imaging method according to claim 14, further comprising:
transmitting the at least one image to the evaluation unit of the imaging system.
